(19) United States
(12) Patent Application Publication
(10) Pub. No.: US 2019/0243367 A1
(43) Pub. Date: Aug. 8, 2019

(54) Precise Localization And V2X Communication For Autonomous Driving Vehicles

(71) Applicants: Qian Huang, Santa Clara, CA (US); Tianyu Li, San Jose, CA (US); Michelle Huang, San Jose, CA (US); Jennie Yuan, Santa Clara, CA (US); Winnie Huang, Sunnyvale, CA (US)

(72) Inventors: Qian Huang, Santa Clara, CA (US); Tianyu Li, San Jose, CA (US); Michelle Huang, San Jose, CA (US); Jennie Yuan, Santa Clara, CA (US); Winnie Huang, Sunnyvale, CA (US)

(21) Appl. No.: 16/263,470

(22) Filed: Jan. 31, 2019

Related U.S. Application Data
(60) Provisional application No. 62/626,151, filed on Feb. 5, 2018.

(51) Int. Cl. G05D 1/02; G06K 9/00; G01C 21/32; H04W 4/40

(52) U.S. Cl. CPC G05D 1/028; G05D 1/0246; G05D 1/0274; G05D 2201/0213; G06K 9/00825; G01C 21/32; H04W 4/40; G06K 9/00818

(57) ABSTRACT

Methods, systems and apparatuses pertaining to pertaining to precise localization and vehicle-to-everything (V2X) communication for autonomous driving vehicles are described. A processor associated with a vehicle wirelessly obtains a respective location of each of one or more traffic control devices. Each of the one or more traffic control devices is installed near or next to a road, an intersection or an area open to vehicular traffic. The processor then determines a location of the vehicle based at least in part on the respective location of each of one or more traffic control devices.

### TECHNICAL FIELD

The present disclosure is generally related to vehicle localization and communication and, more particularly, to techniques pertaining to precise localization and vehicle-to-everything (V2X) communication for autonomous driving vehicles.

### BACKGROUND

Unless otherwise indicated herein, approaches described in this section are not prior art to the claims listed below and are not admitted as prior art by inclusion in this section.

To ensure safety, it is imperative for level 3+ autonomous driving vehicles to localize themselves with accuracy in centimeters (e.g., less than 10 centimeters). Standard Global Positioning Systems (GPS)/Global Navigation Satellite System (GNSS) can determine positions within five to fifteen feet, but such accuracy is not sufficient for autonomous driving vehicles to stay in lanes. Moreover, current traffic control system is primarily designed for human drivers but not for autonomous driving vehicles.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure proposes a system and method for precisely localizing vehicles. The proposed system leverages the same principle of the GPS to locate a traffic control device in accordance with the present disclosure, which may be placed on top of existing infrastructure (e.g., traffic lights and street lamps) to rid of negative impact due to atmospheric effects (e.g., ionospheric delay), multipath effects, and the like. The proposed system is more machine friendly compared to existing traffic control systems. With precise location, vehicles and location-indicating devices in accordance with the present disclosure can broadcast their absolute location and moving path to other vehicles and/or location-indicating devices, thereby avoiding collisions and enhancing traffic safety.

In one aspect, a method in accordance with the present disclosure may involve a processor associated with a vehicle wirelessly obtaining a respective location of each of one or more traffic control devices. Each of the one or more traffic control devices may be installed near or next to a road, an intersection or an area open to vehicular traffic. The method may also involve the processor determining a location of the vehicle based at least in part on the respective location of each of one or more traffic control devices.

In another aspect, a method in accordance with the present disclosure may involve a processor associated with a traffic control device wirelessly transmitting, via a wireless transmitter associated with the traffic control device, radio-frequency (RF) signals containing information pertaining to the traffic control device. The traffic control device may be positioned next to a road, an intersection of roads, or an area open to vehicular traffic. The information may include at least a location associated with the traffic control device and a timestamp.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, explain the principles of the disclosure. It is appreciable that the drawings are not necessarily in scale as some components may be shown to be out of proportion than the size in actual implementation to clearly illustrate the concept of the present disclosure.

FIG. 1 illustrates an example environment in which embodiments in accordance with the present disclosure may be implemented.

FIG. 2 illustrates a flowchart of an example process in accordance with the present disclosure.

FIG. 3 illustrates a flowchart of an example process in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

The present disclosure proposes a machine-friendly traffic control system which may involve communications between a vehicle (e.g., an autonomous driving vehicle) and other objects, vehicles and infrastructure elements via suitable vehicle-to-vehicle (V2V), infrastructure-to-vehicle (I2V) and vehicle-to-everything (V2X) communication protocols, specifications and/or standards. It is believed that, with the proposed system, traffic safety and efficiency in control of traffic flows may be improved with more and more autonomous driving vehicles on the road. In the present disclosure, the notion of “autonomous driving vehicles” (herein used interchangeably with the term “autonomous vehicles”) refers to automobiles that are capable of sensing the environment and navigating without human input. Autonomous driving vehicles may be unmanned ground vehicles with or without human passengers therein. Autonomous driving vehicles may detect or otherwise sense their surroundings by using a variety of techniques such as, for example, radar, laser light, GPS, odometry and computer vision. In the present disclosure the notion of “human-operated vehicles” refers to automobiles that are operated and maneuvered with at least some human input. In the present disclosure, the notion of “precise location” refers to a location of a point in the three-dimensional (3D) space with precision in centimeters. The precise location may be represented in terms of GPS coordinates, GNSS coordinates and/or coordinates of any other positioning systems.

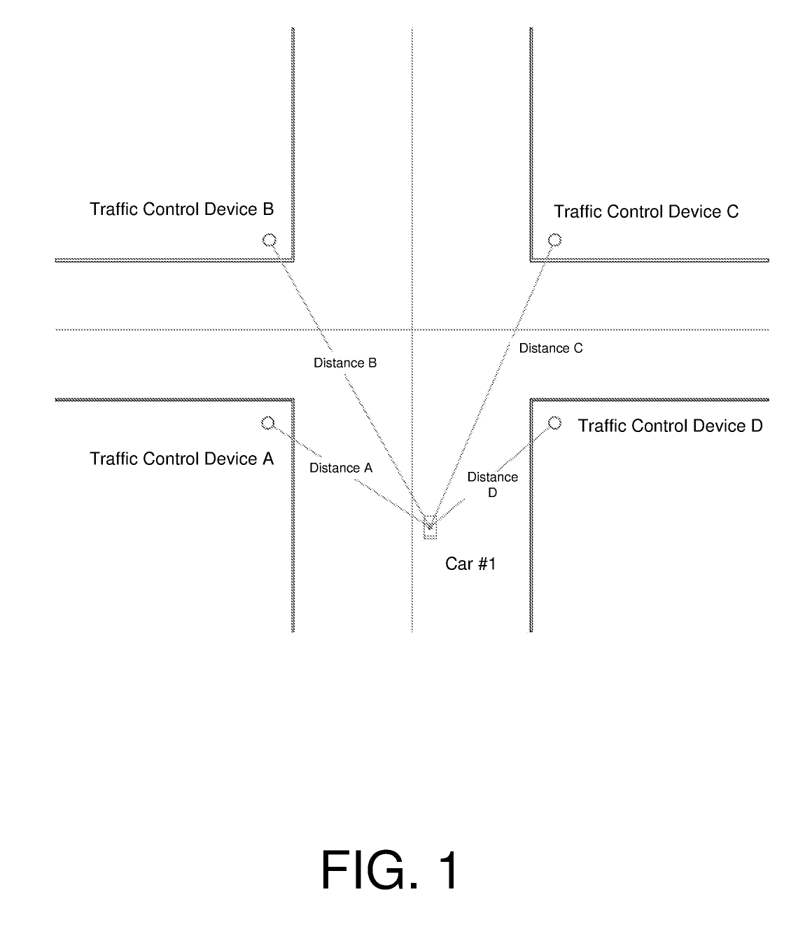

The proposed system utilizes a number of traffic control devices and a number of moveable devices each capable of indicating its precise location (and, optionally, timestamps), as shown in FIG. 1. The traffic control devices may be stationary or otherwise immobile, and may be implemented in, on or as part of roadside infrastructure. For instance, at least some of the traffic control devices may aid, supplement or replace existing traffic lights, traffic signs and the like. The moveable devices may be installed on vehicles (e.g., autonomous vehicles as well as human-operated vehicles) and any other type of transportation tools (e.g., motorcycles and bicycles). The precise location of traffic control devices, which may be stationary or otherwise immobile, may be determined by precise measurement and stored in a memory of each of the traffic control devices (e.g., by an operator of a service provider or a government agency installing the traffic control devices). The precise location of moveable devices, the location of which may change from time to time, may be determined by a processor of each of the moveable devices based on the precise locations indicated in broadcast RF signals received from other moveable devices and/or traffic control devices. In some implementations, at least some of the moveable devices may be equipped with a GPS chip capable of receiving GPS signals from GPS satellites to determine the location of the respective moveable device, and such GPS-based location may be refined or otherwise improved in accuracy by the precise locations indicated in broadcast RF signals received from other moveable devices and/or traffic control devices.

In some implementations, at least some of the traffic control devices and at least some of the moveable devices may include radio-frequency (RF) transmitters or transponders, each of which may broadcast RF signals indicating the precise location and time of the respective RF transponder. The traffic control devices may also be equipped with light(s) such as, for example, green, yellow and red lights to control traffic flow in one or more directions. In some implementations, three or four traffic control devices may, together, function as GPS transmitters to allow vehicles in the vicinity to locate themselves (the vehicles) precisely using the principle of GPS. In some implementations, broadcast information carried in the RF signals transmitted by the traffic control devices may follow the GPS protocol and may include information such as location and timestamp (at very high accuracy such as 0.01 nanosecond or better). In cases of traffic control devices installed near or by a road intersection, the broadcast information may also indicate the status of traffic control signals indicated, transmitted/broadcast or otherwise displayed by the traffic control device. For instance, depending on the situation, the status may be one of the following: block, stop, time to open, open, time to stop, and so on. This way, more information may be provided to the vehicles receiving the broadcast RF signals, thereby enabling vehicles to make optimal decision with respect to energy saving, traffic safety and efficiency. In some implementations, to help simplify the algorithm executed in a vehicle to calculate its respective location, the RF signals from the three or four traffic control devices may be transmitted at the same time (e.g., using techniques such as frequency division multiple access (FDMA) using WiFi channel(s)) to broadcast the RF signals.

In some implementations, at least some of the traffic control devices may also be equipped with camera(s)/image sensor(s) and RF receiver(s). The camera(s)/image sensor(s) of a traffic control device may be used to detect vehicles approaching an intersection by or near which one or more traffic control devices are installed. The RF receiver(s) of a traffic control device may be capable of receiving RF signals from vehicles, objects and other infrastructure elements. For instance, upon receiving RF signals from a vehicle, the RF receiver of a traffic control device may determine the location, speed, future moving path, vehicle identification number (VIN) associated with that vehicle. The traffic control device may then determine and set the status of its associated traffic light based at least in part on the information collected from the camera(s)/image sensor(s) and/or RF receiver(s) thereof.

In some implementation, at least some of the traffic control devices and/or one or more moveable devices may be capable of broadcasting temporary machine-readable map change(s), when there is any change to route(s) and/or road condition(s) due to accident(s), construction(s) and/or weather. Such machine-readable map change(s) may be detected by the cameras/image sensors and/or RF receivers on other traffic control devices and moveable devices. In the present disclosure, the notion of “temporary machine-readable map” refers to a machine-readable map, which may or may not be human readable, that reflects a current condition of one or more roads near, next to or surrounding a traffic control device or a moveable device which generates such temporary machine-readable map. As road conditions may change due to accidents, constructions and weather effects, the condition of the one or more roads in the temporary machine-readable map may change from one moment to the next, hence the temporary nature of the machine-readable map. In other words, a first temporary machine-readable map generated and broadcasted by a given traffic control device (or moveable device) at a first point in time may be the same or different from a second temporary machine-readable map generated and broadcasted by that traffic control device (or moveable device) at a second point in time after the first point in time.

Based on information in the RF signals received by its associated moveable device, an autonomous driving vehicle may be able to precisely locate itself, recalibrate its inertial measurement unit (IMU), and determine whether to drive through an intersection or stop before the intersection (e.g., depending on the status of the traffic control signal). Accordingly, increased energy efficiency and environment benefits may be achieved.

On highways, by utilizing the system of traffic control devices and moveable devices as described above, vehicles (e.g., autonomous driving vehicles as well as human-operated vehicles) may precisely locate themselves. Given the higher speed of moving vehicles on highways, transmission power of the RF transmitters may need to be increased to allow for reception of the broadcast RF signals at longer distances (e.g., up to one or two miles).

In some implementations, machine-readable signage may be utilized to indicate the precise location of a traffic control device, a moveable device, or an infrastructure component. For instance, and without limitation, a QR code sign may be displayed on a traffic light with a point (e.g., red dot) on the sign (e.g., in the middle or in a corner of the sign) to indicate the precise location of the point on the QR code sign on the traffic light (e.g., in GPS coordinates). The camera(s)/image sensor(s) on a vehicle (e.g., an autonomous driving vehicle or a human-operated vehicle) may capture one or more images of the QR code sign with a point on the QR code sign, thereby allowing a processor or an electronic control unit (ECU) of the vehicle to determine a precise location of the vehicle by using the precise location of the point on the QR code sign.

In some implementations, a processor of a vehicle (e.g., an autonomous driving vehicle or a human-operated vehicle) may determine a precise location of the processor based on RF signals received from several traffic control devices and/or several moveable devices of other vehicles (and, when the vehicle is also equipped with a GPS chip, from GPS signals received by the GPS chip from satellites). Once the processor determines its precise location, it may also determine the precise location of each of four corners of the vehicle (e.g., using distances/locations of the four corners relative to the processor). Moreover, the vehicle may broadcast, using a suitable V2V communication protocol to other vehicles in its surrounding, the location of each of four corners of the vehicle, as well as a timestamp (of the time of the broadcast), speed of the vehicle, acceleration (or deceleration) of the vehicle, accuracy level of the locations of the four corners (e.g., GPS, RTX or centimeter level), VIN of the vehicle and any other information. In some implementations, the VIN of the vehicle may be encrypted to protect privacy. This makes other vehicles in the surrounding aware of at least the location and direction of movement of the vehicle that is broadcasting such information. Depending on the accuracy level, other vehicles receiving such information may also use the received information to calibrate their IMU. In some implementations, when the vehicle is parked on the street (e.g., along a curb), the vehicle may continue to broadcast, whether periodically or continuously, some or all of the information described above (e.g., at least the locations of the four corners of the vehicle) to warn other vehicles that are driving by. In some implementations, the effective range of broadcasting by a vehicle may be, for example, up to 1,000 meters when moving and up to 50 meters when parked. In some implementations, the vehicle may also broadcast a direction in which the vehicle intends to move (e.g., for next 50 to 100 meters) to indicate a turn or lane change to be performed by the vehicle. This allows other vehicles that receive such broadcast information to avoid collision with the vehicle that intends to change its direction of movement in the near future. As an example, a police vehicle or police motorcycle may use this V2V technology to warn those vehicles in its surrounding to protect the safety of the police vehicle/motorcycle as well as the passenger(s) in/on it.

In some implementations, a moveable device installed on a vehicle (e.g., an autonomous driving vehicle or a human-operated vehicle) may broadcast a temporary machine-readable map of an area in which the vehicle is located. An example is when a vehicle encounters blockage/obstruction, congestion or detour (e.g., due to accident or construction), a processor on the vehicle may define a temporary machine-readable map of the affected area, and the vehicle may broadcast the temporary machine-readable map of the area that is affected by the blockage, congestion or detour.

### Illustrative Implementations

In view of the above, select features of the proposed system in accordance with the present disclosure are listed below. It is noteworthy that the features listed below are illustrative and do not limit the scope of the inventive concept of the present disclosure.

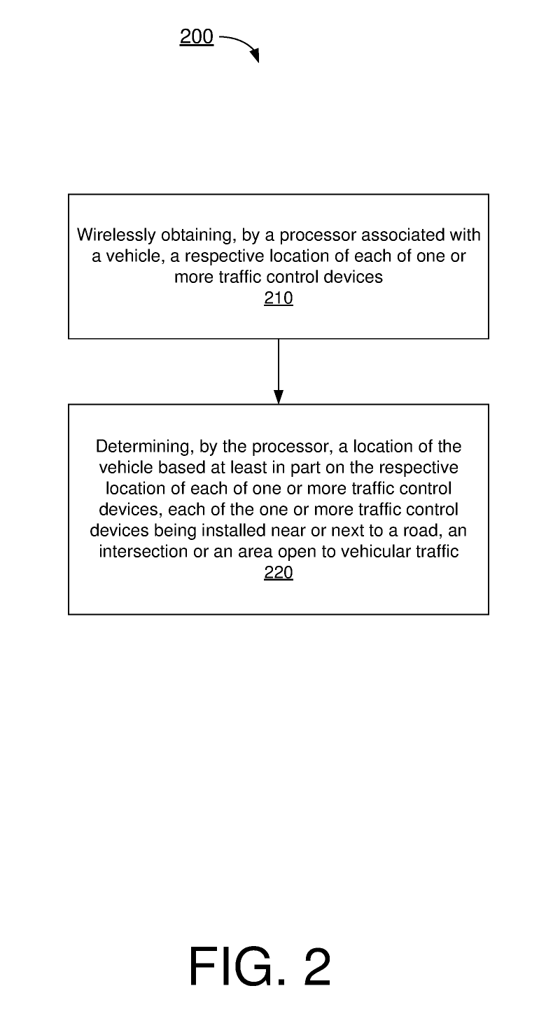

FIG. 2 illustrates a flowchart of an example process 200 of a method in accordance with the present disclosure. Referring to FIG. 2, at 210, the method may involve a processor associated with a vehicle wirelessly obtaining a respective location of each of one or more traffic control devices. Each of the one or more traffic control devices may be installed near or next to a road, an intersection or an area open to vehicular traffic. At 220, the method may also involve the processor determining a location of the vehicle based at least in part on the respective location of each of one or more traffic control devices.

In some implementations, in wirelessly obtaining the respective location of each of one or more traffic control devices, the method may involve the processor wirelessly receiving a radio-frequency (RF) signal from each of the one or more traffic control devices.

In some implementations, wirelessly receiving the RF signal from each of the one or more traffic control devices, the method may involve the processor wirelessly receiving the RF signal from each of the one or more traffic control devices in compliance with one or more of Institute of Electrical and Electronics Engineers (IEEE) 802.11 specifications.

In some implementations, the one or more traffic control devices may include multiple traffic control devices. In such cases, in wirelessly receiving the RF signal from each of the one or more traffic control devices, the method may involve the processor wirelessly receiving RF signals broadcasted simultaneously from the multiple traffic control devices with frequency division multiple access (FDMA).

In some implementations, in wirelessly receiving the RF signal from each of the one or more traffic control devices, the method may involve the processor wirelessly receiving the RF signal broadcasted from each of the one or more traffic control devices in compliance with a Global Positioning System (GPS) protocol.

In some implementations, the RF signal may contain information including the respective location and a timestamp.

In some implementations, the information contained in the RF signal may further include status of a traffic control signal associated with a respective one of the one or more traffic control devices.

In some implementations, the status of the traffic control signal associated with the respective one of the one or more traffic control devices may include at least one of the following: (a) a traffic flow is blocked; (b) the traffic flow is stopped; (c) an amount of time until the traffic flow is to change from being stopped to open; (d) the traffic flow is open; and (e) an amount of time until the traffic flow is to change from being open to stopped.

In some implementations, the method may further involve the processor controlling one or more operations of the vehicle according to the status of the traffic control signal associated with at least one of the one or more traffic control devices.

In some implementations, in wirelessly obtaining the respective location of each of one or more traffic control devices, the method may involve the processor capturing, via one or more image sensors associated with the vehicle, one or more images of a respective sign associated with each of the one or more traffic control devices. The respective sign may indicate the respective location of a respective one of the one or more traffic control devices.

In some implementations, the respective sign may display a respective quick response (QR) code indicating a location of a point on the respective sign.

In some implementations, in determining the location of the vehicle, the method may involve the processor determining a location of each of four corners of the vehicle.

In some implementations, the method may further involve the processor broadcasting, via a wireless transmitter associated with the vehicle, information including locations of the four corners of the vehicle.

In some implementations, the information broadcasted via the wireless transmitter associated with the vehicle may also include a timestamp, a speed of the vehicle, an acceleration or deceleration of the vehicle, a level of accuracy of the locations of the four corners, a vehicle identification number (VIN), or a combination thereof. The VIN may be encrypted.

In some implementations, the method may further involve the processor calibrating an inertial measurement unit (IMU) associated with the vehicle based at least in part on the determined location of the vehicle.

In some implementations, the method may further involve the processor wirelessly receiving, via a wireless receiver associated with the vehicle, information broadcasted by one other vehicle. Additionally, the method may involve the processor determining locations of four corners of the other vehicle, a speed of the other vehicle and a direction of movement of the other vehicle based at least in part on the information broadcasted by the other vehicle. In some implementations, the method may also involve the processor calibrating an IMU associated with the vehicle based at least in part on the information broadcasted by the other vehicle.

In some implementations, the method may further involve the processor broadcasting, via a wireless transmitter associated with the vehicle, a turn or a change of lane to be performed by the vehicle within a predefined amount of distance of movement of the vehicle.

In some implementations, the method may further involve the processor receiving, from one or more sensors associated with the vehicle, sensor data indicating one or more road conditions surrounding the vehicle in an area. Moreover, the method may involve the processor generating a machine-readable map indicating the one or more road conditions in the area. Furthermore, the method may involve the processor broadcasting, via a wireless transmitter associated with the vehicle, the machine-readable map.

In some implementations, the method may further involve the processor wirelessly receiving, from a wireless receiver associated with the vehicle, a machine-readable map indicating one or more road conditions pertaining to an area. Additionally, the method may involve the processor controlling one or more operations of the vehicle when traveling in the area based at least in part on the machine-readable map.

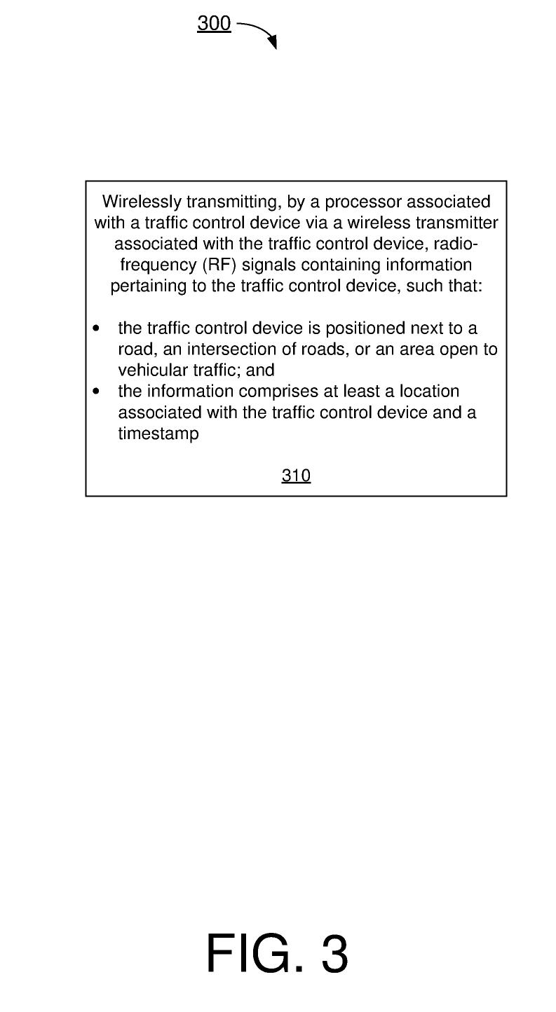

FIG. 3 illustrates a flowchart of an example process 300 of a method in accordance with the present disclosure. Referring to FIG. 3, at 310, the method may involve a processor associated with a traffic control device wirelessly transmitting, via a wireless transmitter associated with the traffic control device, RF signals containing information pertaining to the traffic control device. The traffic control device may be positioned next to a road, an intersection of roads, or an area open to vehicular traffic. The information may include at least a location associated with the traffic control device and a timestamp.

In some implementations, in wirelessly transmitting the RF signals, the method may involve the processor wirelessly transmitting the RF signals in compliance with one or more of IEEE 802.11 specifications.

In some implementations, in wirelessly transmitting the RF signals, the method may involve the processor wirelessly transmitting the RF signals in compliance with a GPS protocol.

In some implementations, the status of the traffic control signal may include at least one of the following: (a) a traffic flow is blocked; (b) the traffic flow is stopped; (c) an amount of time until the traffic flow is to change from being stopped to open; (d) the traffic flow is open; and (e) an amount of time until the traffic flow is to change from being open to stopped.

In some implementations, the method may further involve the processor wirelessly obtaining information indicating one or more vehicles approaching the traffic control device. Additionally, the method may involve the processor determining status of a traffic control signal associated with the traffic control device responsive to the information indicating the one or more vehicles approaching the traffic control device. Moreover, the method may involve the processor wirelessly transmitting, via a wireless transmitter associated with the traffic control device, information indicating the status of the traffic control signal.

In some implementations, in wirelessly obtaining the information indicating the one or more vehicles approaching the traffic control device, the method may involve the processor performing at least one of: (1) receiving image data from one or more image sensors associated with the traffic control device such that the processor detects the one or more vehicles approaching the traffic control device based at least in part on the image data; and (2) wirelessly receiving, via a wireless receiver associated with the traffic control device, information broadcasted by each of the one or more vehicles.

In some implementations, the information broadcasted by at least one of the one or more vehicles may include locations of four corners of the vehicle, a timestamp, a speed of the vehicle, an acceleration or deceleration of the vehicle, a level of accuracy of the locations of the four corners, a vehicle identification number (VIN), or a combination thereof. The VIN may be encrypted.

In some implementations, the method may further involve the processor receiving information indicating one or more road conditions of an area surrounding the traffic control device. Moreover, the method may involve the processor generating a machine-readable map indicating the one or more road conditions in the area. Furthermore, the method may involve the processor broadcasting, via the wireless transmitter, the machine-readable map.

In some implementations, in receiving the information indicating the one or more road conditions, the method may involve the processor receiving, from one or more sensors associated with the traffic control device, sensor data representing the information indicating the one or more road conditions.

In some implementations, in receiving the information indicating the one or more road conditions, the method may involve the processor wirelessly receiving, via a wireless receiver associated with the traffic control device, the information indicating the one or more road conditions.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
wirelessly obtaining, by a processor associated with a vehicle, a respective location of each of one or more traffic control devices; and
determining, by the processor, a location of the vehicle based at least in part on the respective location of each of one or more traffic control devices,
wherein each of the one or more traffic control devices is installed near or next to a road, an intersection or an area open to vehicular traffic.

2. The method of claim 1, wherein the wirelessly obtaining the respective location of each of one or more traffic control devices comprises wirelessly receiving a radio-frequency (RF) signal from each of the one or more traffic control devices.

3. The method of claim 2, wherein the wirelessly receiving the RF signal from each of the one or more traffic control devices comprises wirelessly receiving the RF signal from each of the one or more traffic control devices in compliance with one or more of Institute of Electrical and Electronics Engineers (IEEE) 802.11 specifications.

4. The method of claim 2, wherein the one or more traffic control devices comprise multiple traffic control devices, and wherein the wirelessly receiving the RF signal from each of the one or more traffic control devices comprises wirelessly receiving RF signals broadcasted simultaneously from the multiple traffic control devices with frequency division multiple access (FDMA).

5. The method of claim 2, wherein the wirelessly receiving the RF signal from each of the one or more traffic control devices comprises wirelessly receiving the RF signal broadcasted from each of the one or more traffic control devices in compliance with a Global Positioning System (GPS) protocol.

6. The method of claim 5, wherein the RF signal contains information comprising the respective location and a timestamp.

7. The method of claim 6, wherein the information contained in the RF signal further comprises status of a traffic control signal associated with a respective one of the one or more traffic control devices.

8. The method of claim 7, wherein the status of the traffic control signal associated with the respective one of the one or more traffic control devices comprises at least one of:
a traffic flow is blocked;
the traffic flow is stopped;
an amount of time until the traffic flow is to change from being stopped to open;
the traffic flow is open; and
an amount of time until the traffic flow is to change from being open to stopped.

9. The method of claim 7, further comprising:
controlling, by the processor, one or more operations of the vehicle according to the status of the traffic control signal associated with at least one of the one or more traffic control devices.

10. The method of claim 1, wherein the wirelessly obtaining the respective location of each of one or more traffic control devices comprises capturing, via one or more image sensors associated with the vehicle, one or more images of a respective sign associated with each of the one or more traffic control devices, and wherein the respective sign indicates the respective location of a respective one of the one or more traffic control devices.

11. The method of claim 10, wherein the respective sign displays a respective quick response (QR) code indicating a location of a point on the respective sign.

12. The method of claim 1, wherein the determining of the location of the vehicle comprises determining a location of each of four corners of the vehicle.

13. The method of claim 12, further comprising:
broadcasting, by the processor via a wireless transmitter associated with the vehicle, information comprising locations of the four corners of the vehicle.

14. The method of claim 13, wherein the information broadcasted via the wireless transmitter associated with the vehicle further comprises a timestamp, a speed of the vehicle, an acceleration or deceleration of the vehicle, a level of accuracy of the locations of the four corners, an encrypted vehicle identification number (VIN), or a combination thereof.

15. The method of claim 1, further comprising:
calibrating, by the processor, an inertial measurement unit (IMU) associated with the vehicle based at least in part on the determined location of the vehicle.

16. The method of claim 1, further comprising:
wirelessly receiving, by the processor via a wireless receiver associated with the vehicle, information broadcasted by one other vehicle; and
determining, by the processor, locations of four corners of the other vehicle, a speed of the other vehicle and a direction of movement of the other vehicle based at least in part on the information broadcasted by the other vehicle.

17. The method of claim 16, further comprising:
calibrating, by the processor, an inertial measurement unit (IMU) associated with the vehicle based at least in part on the information broadcasted by the other vehicle.

18. The method of claim 1, further comprising:
broadcasting, by the processor via a wireless transmitter associated with the vehicle, a turn or a change of lane to be performed by the vehicle within a predefined amount of distance of movement of the vehicle.

19. The method of claim 1, further comprising:
receiving, by the processor from one or more sensors associated with the vehicle, sensor data indicating one or more road conditions surrounding the vehicle in an area;
generating, by the processor, a machine-readable map indicating the one or more road conditions in the area; and
broadcasting, by the processor via a wireless transmitter associated with the vehicle, the machine-readable map.

20. The method of claim 1, further comprising:
wirelessly receiving, by the processor from a wireless receiver associated with the vehicle, a machine-readable map indicating one or more road conditions pertaining to an area; and
controlling, by the processor, one or more operations of the vehicle when traveling in the area based at least in part on the machine-readable map.

21-30. (canceled)
